(19) United States
(12) Patent Application Publication
(10) Pub. No.: US 2013/0313208 A1
(43) Pub. Date: Nov. 28, 2013

(54) OUTDOOR UNIT SYSTEM AND HOLDER FOR OUTDOOR UNIT

(71) Applicants: YU CHENG LIN, HSINCHU (TW); I FENG OU, HSINCHU (TW)

(72) Inventors: YU CHENG LIN, HSINCHU (TW); I FENG OU, HSINCHU (TW)

(73) Assignee: MICROELECTRONICS TECHNOLOGY, INC., HSINCHU (TW)

(21) Appl. No.: 13/479,714

(22) Filed: May 24, 2012

(51) Int. Cl. F16M 13/00

(52) U.S. Cl. 211/13.1

(57) ABSTRACT

A holder for an outdoor unit comprises a frame and a supporting part. The frame includes at least one fixing aperture configured for fixing the outdoor unit. The supporting part configured for alignment between the outdoor unit and the frame includes a connecting portion, an intermediate portion, and a terminal portion. The connection portion is attached to the frame. The intermediate portion is configured for supporting the outdoor unit. The terminal portion connects with the intermediate portion.

### BACKGROUND OF THE INVENTION

1. Technical Field

The present invention relates to a holder for an outdoor unit, and more particularly, to an outdoor unit system capable of temporary alignment between the holder and the outdoor unit.

2. Background

During installation of an outdoor satellite receiver unit, the outdoor unit needs to be aligned in a position to receive a strong signal. In a typical prior art system, an antenna system has an antenna dish and an outdoor unit that may include a transceiver, feed horn, and other antenna components. Various devices can be used to help an installer connect the antenna dish to the outdoor unit. One such device is a separate engaging device (not shown) that connects the antenna to the outdoor unit, capable of transmitting/receiving signals from the antenna. This engaging device is convenient for a professional installer who can use it during the outdoor unit installation. However, the typical engaging device is complicated and not convenient for use during installation by the consumer, since the engaging device makes it difficult to adjust the error in connection between the outdoor unit and the antenna.

Thus, there is a need for an outdoor unit system and a holder for an outdoor unit with an inexpensive and convenient-to-use design. Such outdoor unit system and the holder would preferably be useable by a typical consumer or non-professional installer for adjustable installation and should be able to obtain a strong satellite signal.

### SUMMARY

The present invention discloses a holder for an outdoor unit. The holder includes a frame and a supporting part. The frame includes at least one fixing aperture configured for fixing the outdoor unit. The supporting part is configured for alignment between the outdoor unit and the frame. The supporting part includes a connecting portion, an intermediate portion, and a terminal portion. The connecting portion is attached to the frame. The intermediate portion is configured for supporting the outdoor unit. The terminal portion connects with the intermediate portion.

The present invention further discloses an outdoor unit system comprising an outdoor unit and a holder, which includes a frame and a supporting part. The frame includes at least one fixing aperture, which is configured for fixing the outdoor unit. The supporting part is configured for alignment between the outdoor unit and the frame, and includes a connecting portion attached to the frame, an intermediate portion configured for supporting the outdoor unit, and a terminal portion connecting the intermediate portion. The outdoor unit includes a fixing part through which the supporting part passes, while the supporting part is configured to support the fixing part.

The foregoing has outlined rather broadly the features and technical benefits of the disclosure in order that the detailed description of the invention that follows may be better understood. Additional features and benefits of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the disclosure. It should also be realized by those skilled in the art that such equivalent constructions do not depart from the spirit and scope of the invention as set forth in the appended claims.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 is a schematic view of a holder in accordance with an embodiment of the present invention;

FIG. 2 is a schematic view of a holder, an antenna frame, and an outdoor unit in accordance with an embodiment of the present invention;

FIG. 3 is a schematic view of an assembly of an outdoor unit system including the holder, the antenna frame, the outdoor unit, and the antenna in accordance with an embodiment of the present invention;

FIG. 4 is a schematic view of a holder in accordance with another embodiment of the present invention;

FIG. 5 is a schematic view of a holder, an antenna frame, and an outdoor unit in accordance with another embodiment of the present invention;

FIG. 6 is a schematic view of an assembly of an outdoor unit system including the holder, the antenna frame, the outdoor unit, and the antenna in accordance with another embodiment of the present invention;

FIG. 7 is a schematic view of a holder in accordance with another embodiment of the present invention;

FIG. 8 is a schematic view of a holder, an antenna frame, and an outdoor unit in accordance with another embodiment of the present invention;

FIG. 9 is a schematic view of an assembly of an outdoor unit system including the holder, the antenna frame, the outdoor unit, and the antenna in accordance with another embodiment of the present invention;

FIG. 10 is a schematic view of another holder in accordance with another embodiment of the present invention; and

FIG. 11 is another schematic view of the holder in FIG. 10 in accordance with another embodiment of the present invention.

### DETAILED DESCRIPTION

References to “one embodiment,” “an embodiment,” “exemplary embodiment,” “other embodiments,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present invention is directed to a holder for an outdoor unit and an outdoor unit system thereof. In order to make the present invention completely comprehensible, detailed steps and structures are provided in the following description. Obviously, implementation of the present invention does not limit special details known by persons skilled in the art. In addition, known structures and steps are not described in detail, so as not to unnecessarily limit the present invention. Preferred embodiments of the present invention will be described below in detail. However, in addition to the detailed description, the present invention may also be widely implemented in other embodiments. The scope of the present invention is not limited to the detailed description, and is defined by the claims.

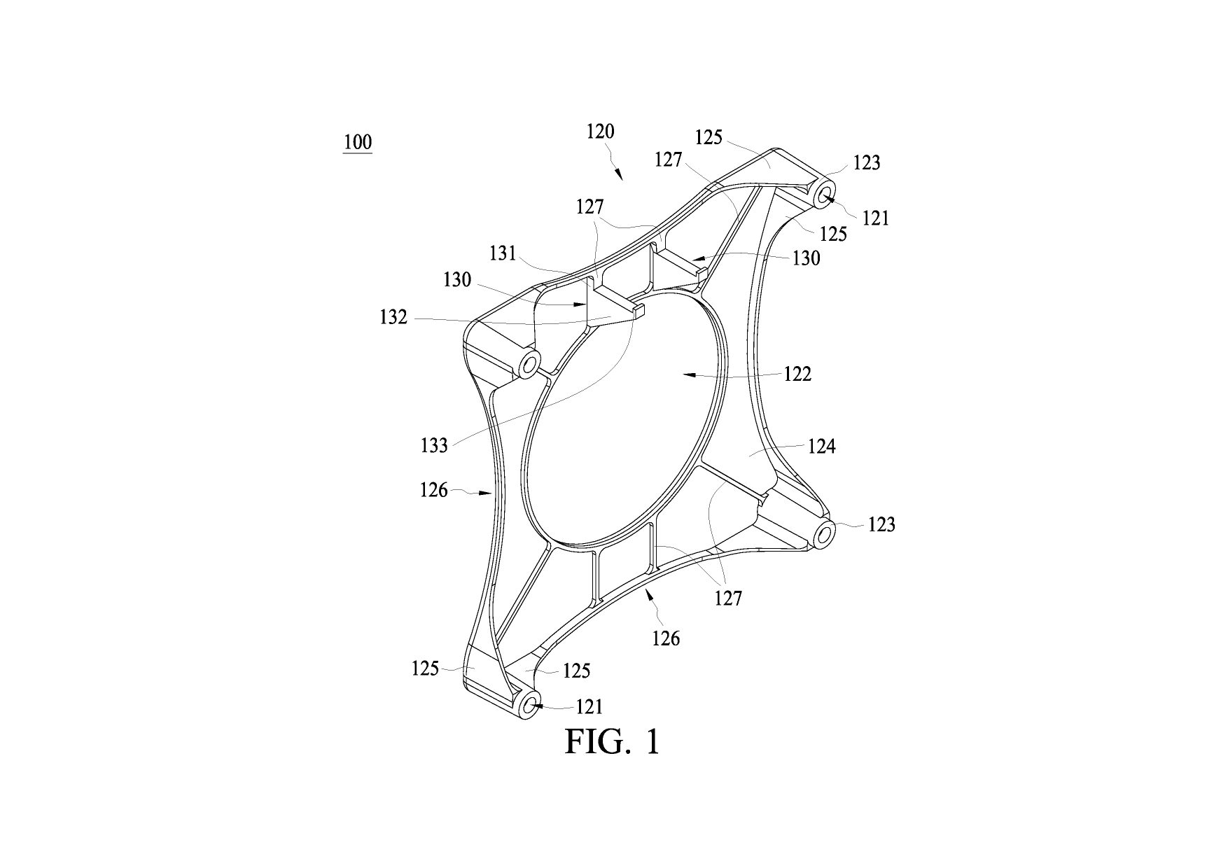

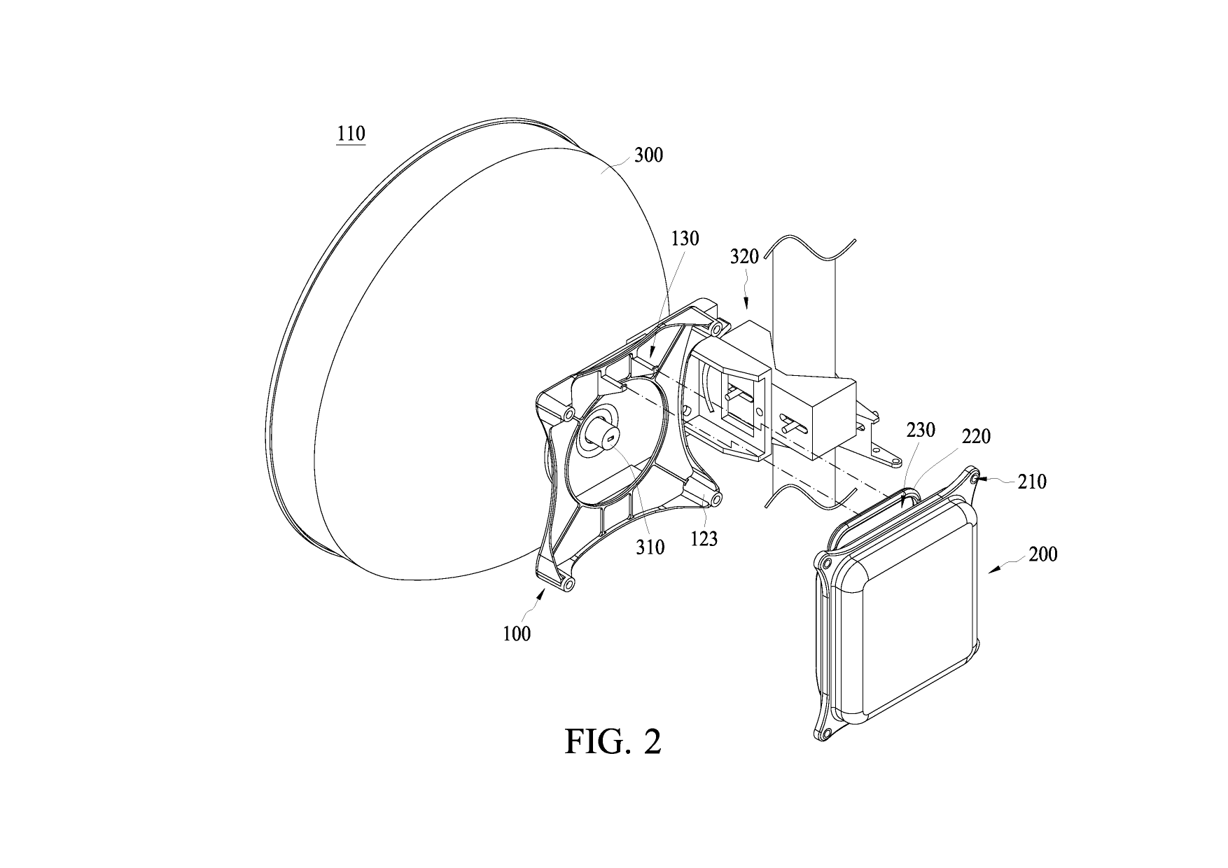

In an embodiment shown in FIG. 1, a holder 100 comprises a frame 120 and two supporting parts 130. In another embodiment, the supporting part 130 may be, but is not limited to, a single supporting part 130 in accordance with different designs. The frame 120 includes at least one fixing aperture 121, which is configured for fixing the outdoor unit 200 shown in FIG. 2. In the embodiment, the supporting part 130 and the frame 120 are integrated; however, in other embodiments (not shown) the supporting part 130 and the frame 120 can be connected by soldering, engaging, screwing or other connection methods.

In the embodiment shown in FIG. 1, the frame 120 further comprises a center opening 122, which is configured for the connection member (not shown) of the outdoor unit 200 shown in FIG. 2 to pass through. In other words, the center opening 122 allows the connection member of the outdoor unit 200 to penetrate so as to connect with a terminal 310 of an antenna 300 shown in FIG. 2.

In the embodiment shown in FIG. 1, the side 126 of the frame 120 is formed as an arc-like shape, which can save material of the frame 120 and avoid the damage by external stress to the vulnerable side 126 of the frame 120. Moreover, the frame 120 further includes a plurality of protruding ribs 127, which are configured for reinforcing the frame 120 so as to avoid damage due to the external stress.

In the embodiment shown in FIG. 1, the frame 120 further includes at least one cylinder 123, which protrudes from the inner surface 124 of the frame 120. Since the fixing aperture 121 is formed at the center of the cylinder 123, the cylinder 123 can help fix the outdoor unit 200, as shown in FIG. 2. In addition, in order to improve the robustness of the cylinder 123, the frame 120 further includes two stabilizing parts 125, which connect with the cylinder 123 so as to reinforce the structure of the cylinder 123. As shown in FIG. 2, the outdoor unit 200 includes at least one hole 210. Screws or studs (not shown) can pass through the hole 210 to engage the inner threaded wall (not shown) inside the fixing aperture 121 of the cylinder 123 so as to fix the outdoor unit 200. However, since the outdoor unit 200 is too heavy to be easily fixed by the consumer, the supporting part 130 is required.

In the embodiment shown in FIG. 1, the supporting parts 130 are disposed on the protruding ribs 127 and located at the same side with respect to the center opening 122. Since the outdoor unit 200 is too heavy to be easily fixed by the consumer, the supporting parts 130 are configured for alignment between the outdoor unit 200 shown in FIG. 2 and the frame 120 for temporarily positioning the outdoor unit 200 so as to allow the outdoor unit 200 to be fixed in position by a single installer. Without the aid of the supporting parts 130, a single installer would have to use one hand to temporarily position the outdoor unit 200 and use the other hand to screw the outdoor unit 200 to the holder 120.

In the embodiment shown in FIG. 1, the supporting part 130 includes a connecting portion 131, an intermediate portion 132, and a terminal portion 133. In the embodiment, the connecting portion 131 is attached to the protruding rib 127 of the frame 120. The intermediate portion 132 connecting with the connecting portion 131 is configured for supporting and positioning the outdoor unit 200 shown in FIG. 2. The terminal portion 133 connecting with the intermediate portion 132 extends substantially perpendicular to the normal direction of the frame 120 to avoid disengagement of the outdoor unit 200 from the frame 120.

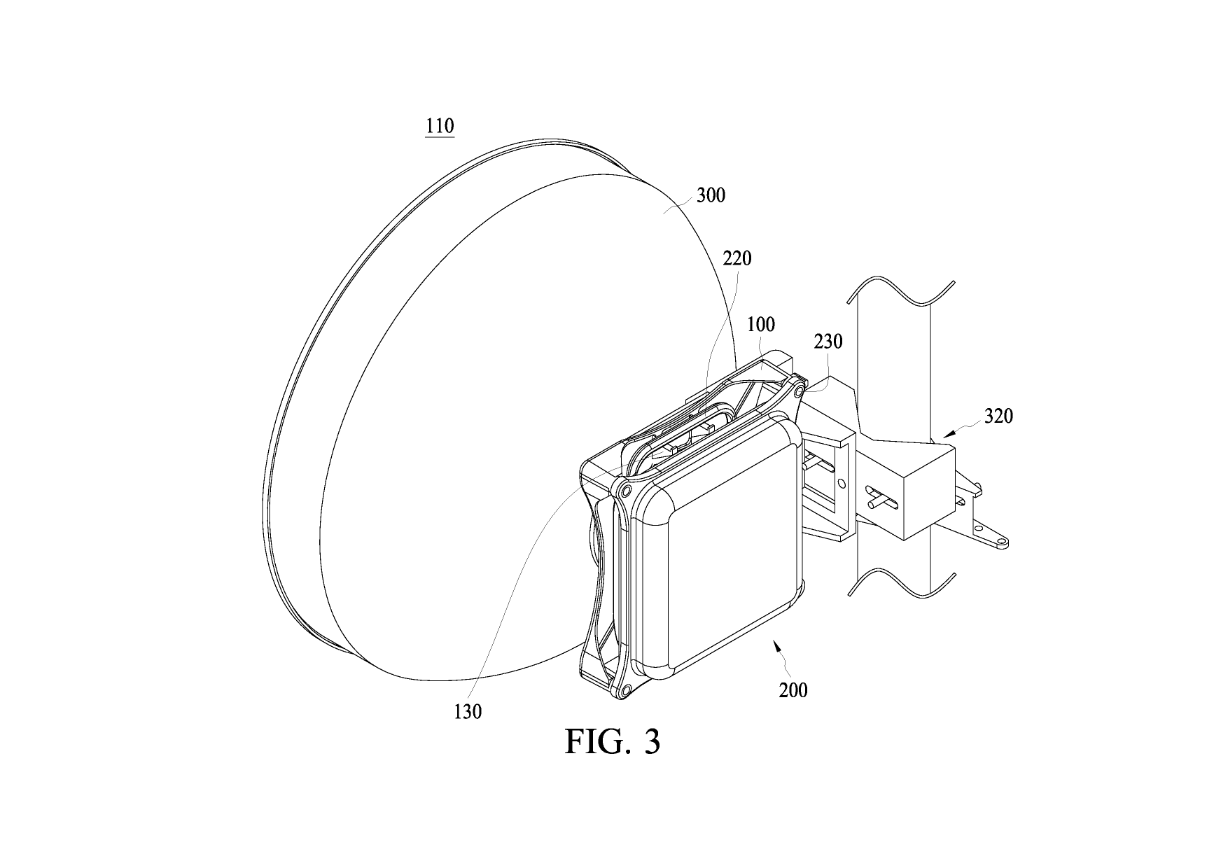

In the embodiment shown in FIGS. 2 and 3, an outdoor unit system 110 comprises an outdoor unit 200 including a positioning part 220 and the above-mentioned holder 100 shown in FIG. 1. The holder 100 is initially fixed on the antenna frame 320. Since the weight of the holder 100 is less than the weight of the outdoor unit 200, the consumer can easily fix the holder 100 on the antenna frame 320. After the holder 100 is fixed, the outdoor unit 200 can be temporarily positioned on the holder 100 by hanging the outdoor unit 200 on the supporting part 130. In particular, the supporting part 130 may pass through the opening 230 defined by the positioning part 220 and then the supporting part 130 is configured to support the positioning part 220 for aligning the outdoor unit 200 with the frame 120. Finally, screws or studs 240 are capable of passing through the hole 210 to engage the inner threaded wall (not shown) inside the cylinder 123 for fixing the outdoor unit 200 as shown in FIG. 3.

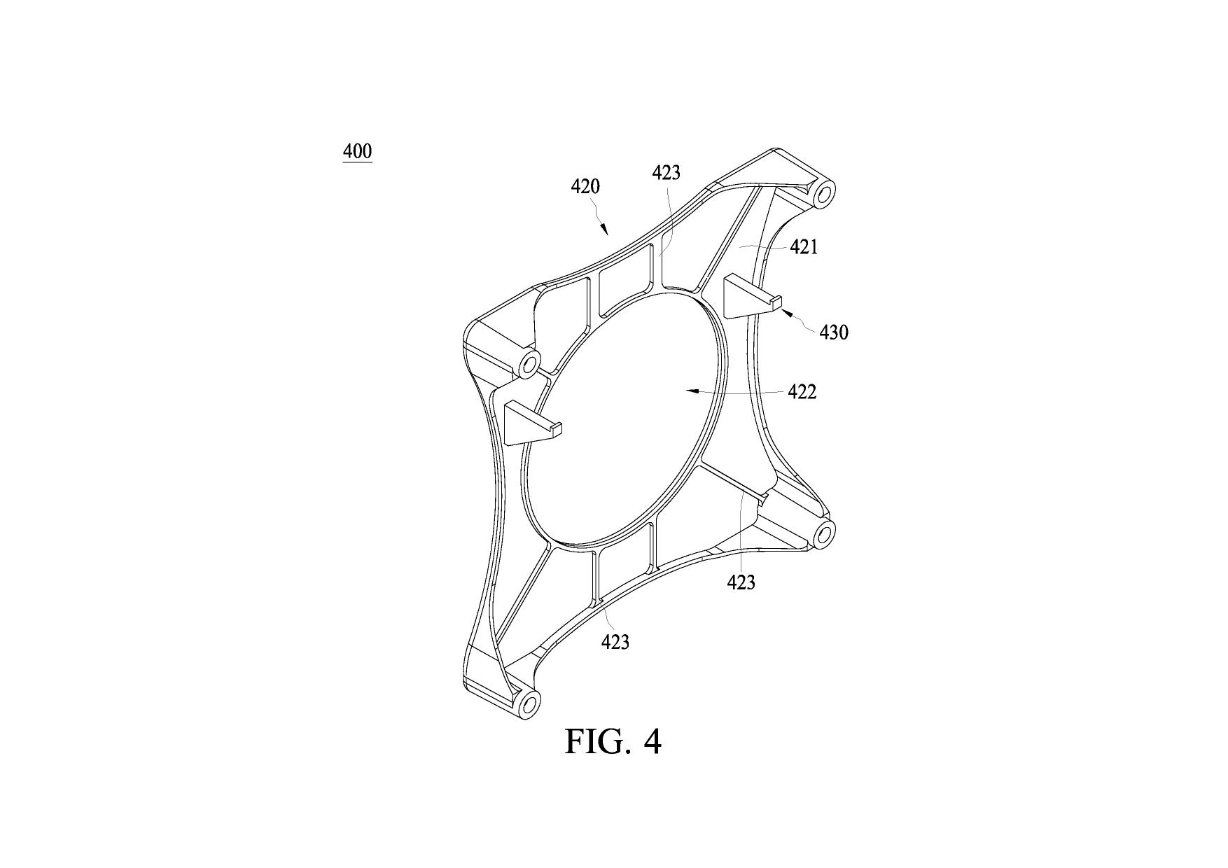

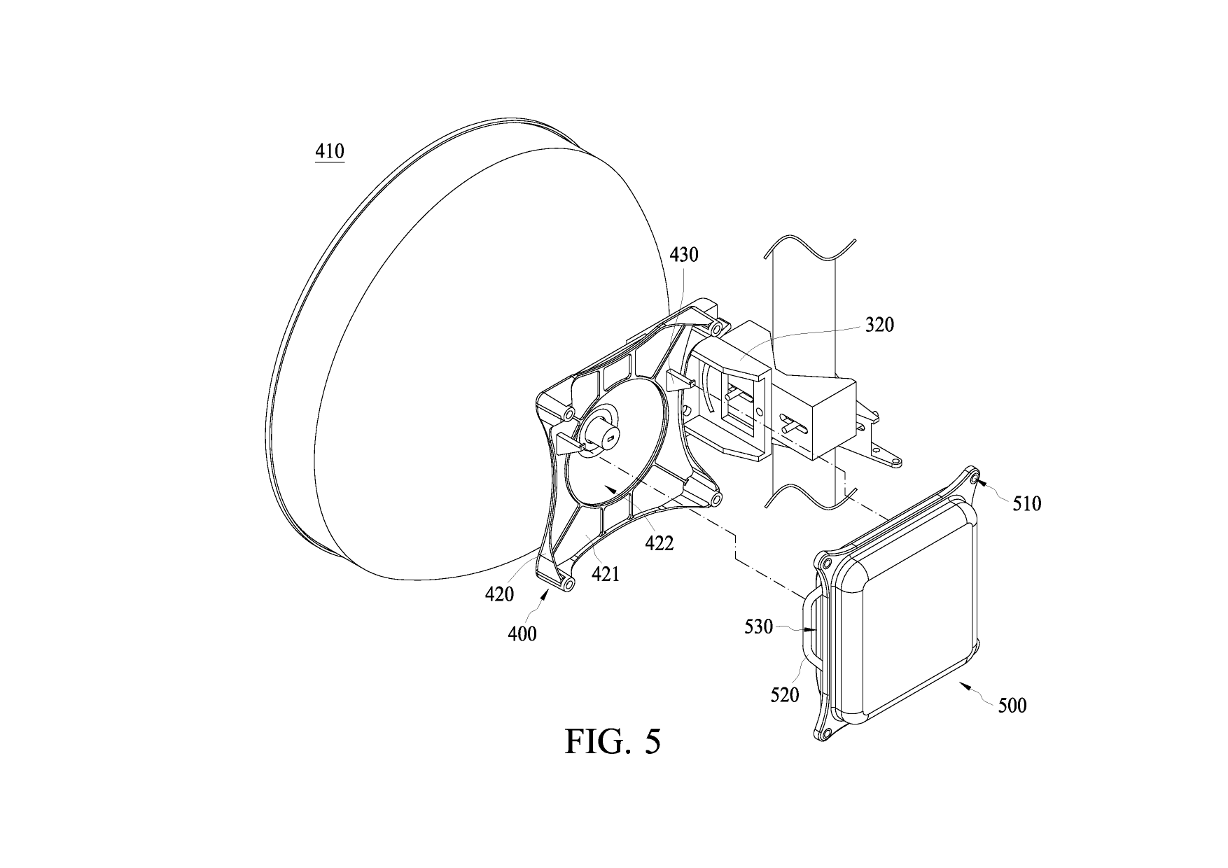

In another embodiment shown in FIG. 4, the holder 400 comprises a frame 420 and two supporting parts 430; however, in other embodiments the supporting part 430 may be, but is not limited to, a single supporting part 430 in accordance with different designs. The supporting parts 430 are disposed on the inner surface 421, instead of on the protruding rib 423. When the supporting parts 430 receive the external stress due to the outdoor unit 500 shown in FIG. 5, the supporting parts 430 disposed on the inner surface 421 distribute the external stress on the entire inner surface 421 of the frame 420 so as to avoid damage due to localized focus of the stress.

In addition, the embodiment shown in FIG. 4 illustrates that two supporting parts 430 are separated by the center opening 422. In other words, two supporting parts 430 are located at substantially opposite sides relative to the center opening 422. By such design, the external stress can be distributed on two opposite sides of the frame 420 so as to avoid damage in the upper frame portion due to localized focus of the stress.

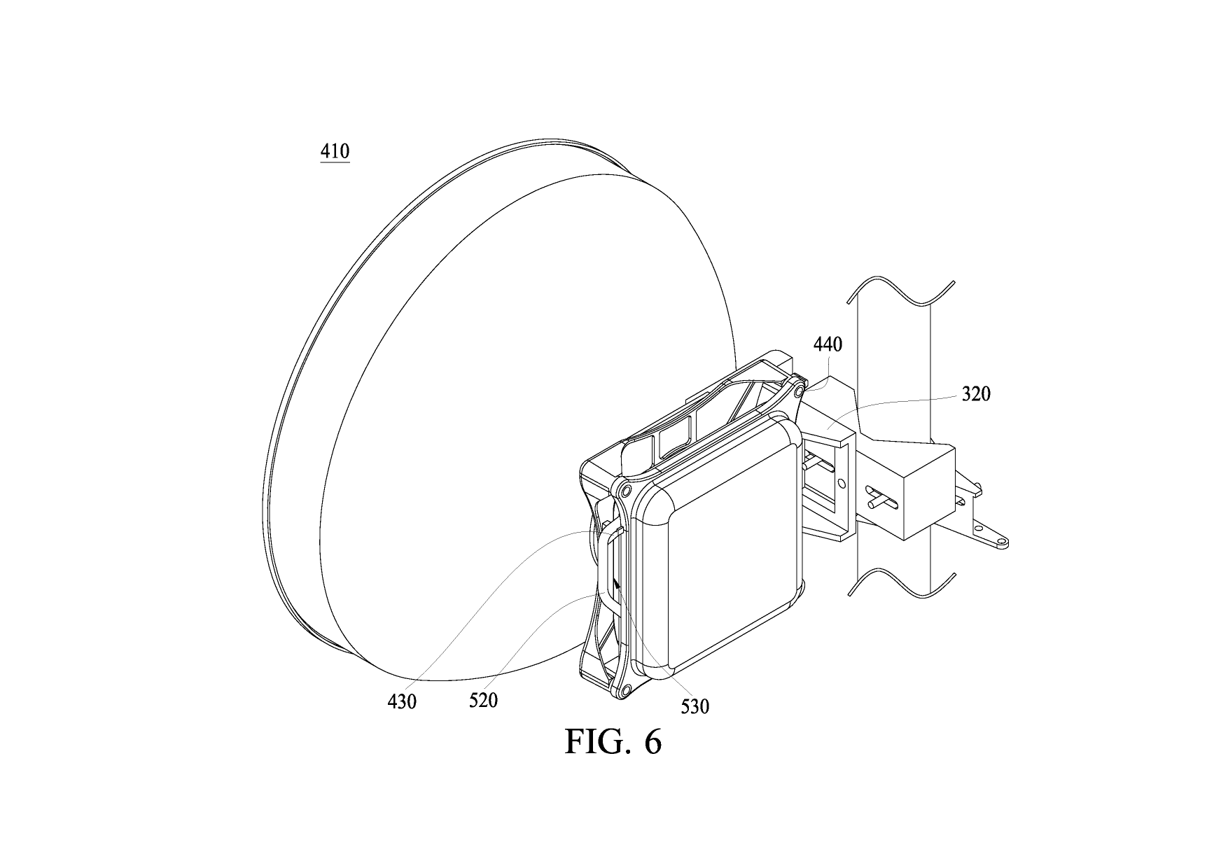

In the embodiment shown in FIG. 5, the outdoor unit system 410 comprises an outdoor unit 500 including two positioning parts 520 disposed corresponding to the supporting parts 430 and the holder 400. In the embodiment shown in FIGS. 5 and 6, the holder 400 is initially fixed on the antenna frame 320. After the holder 400 is fixed, the outdoor unit 500 can be temporarily positioned on the holder 400 by hanging the outdoor unit 500 on the supporting parts 430. Particularly, the supporting part 430 may pass through the corresponding opening 530 defined by the positioning part 520 and then the supporting part 430 is configured to support the positioning part 420 for aligning the outdoor unit 500 with the frame 400. Finally, screws or studs 440 are capable of passing through the hole 510 to engage the frame 400 for fixing the outdoor unit 500 as shown in FIG. 6.

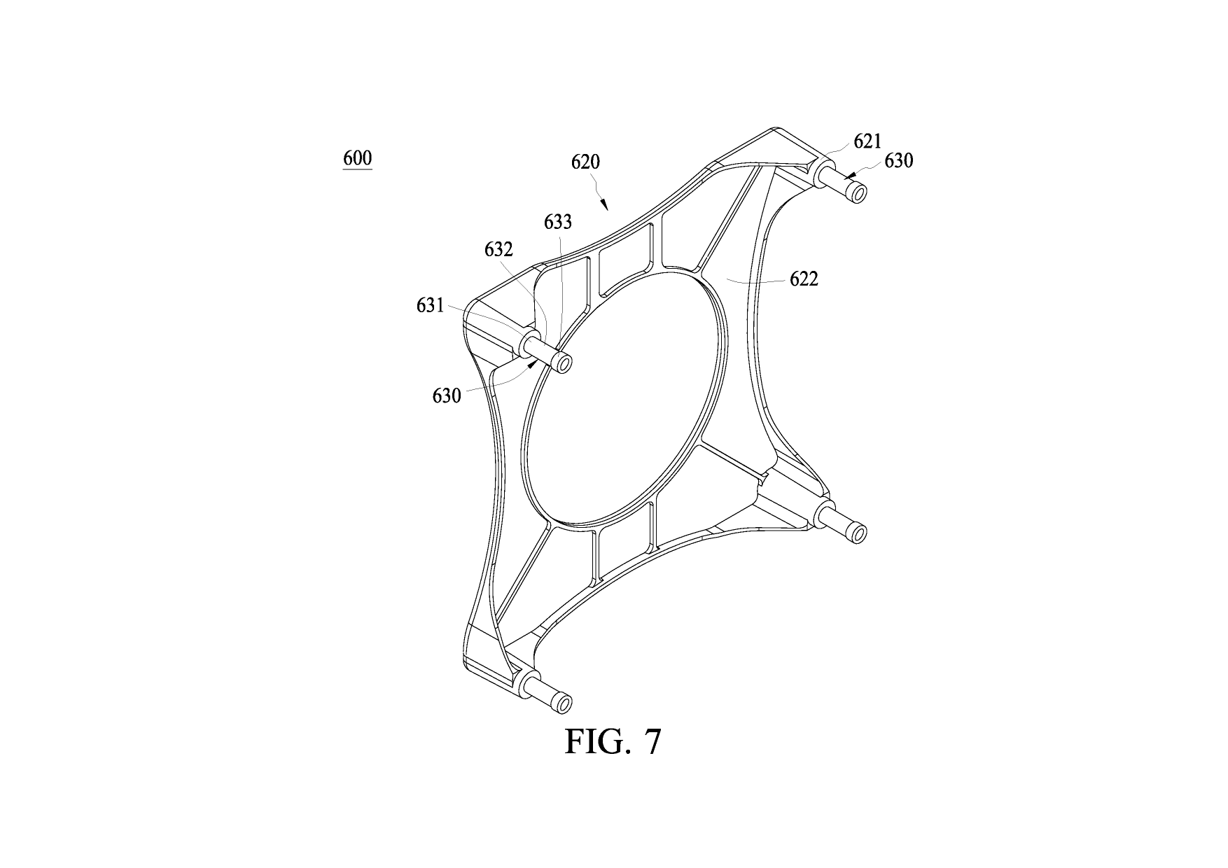

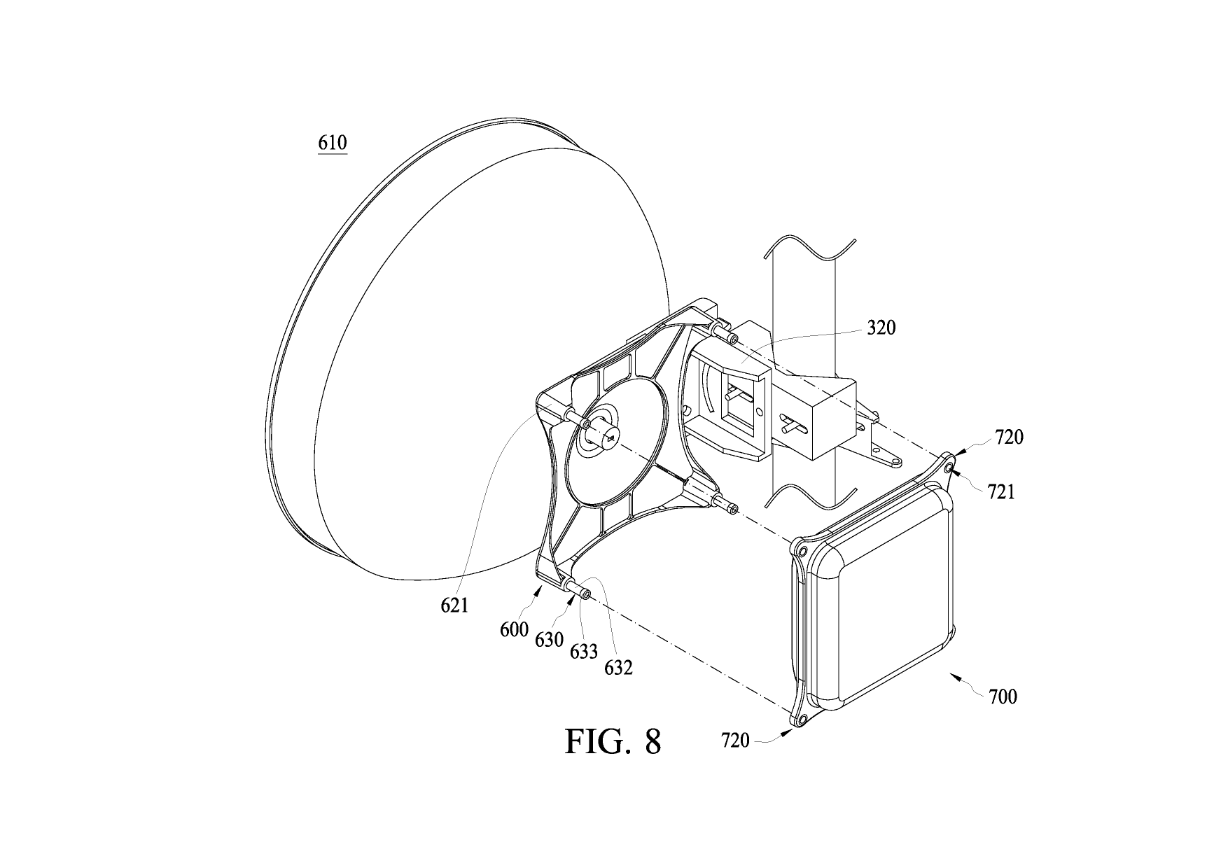

In another embodiment shown in FIG. 7, the holder 600 comprises a frame 620 and at least one supporting part 630. In the embodiment, the frame 620 includes at least one cylinder 621, which protrudes from the inner surface 622 of the frame. The supporting part 630 is a tube, which is disposed on the cylinder 621. The supporting part 630 includes a connecting portion 631 attached to the cylinder 621 of the frame 600, an intermediate portion 632 and a terminal portion 633. The intermediate portion 632 is configured for supporting the outdoor unit 700 shown in FIG. 8. The terminal portion 633 connecting with the intermediate portion 632 extends substantially perpendicular to the normal direction of the frame 620 to avoid disengaging the outdoor unit 700 shown in FIG. 8 from the frame 620. In other words, the terminal portion 633 extends substantially perpendicular to the axle of supporting part 630.

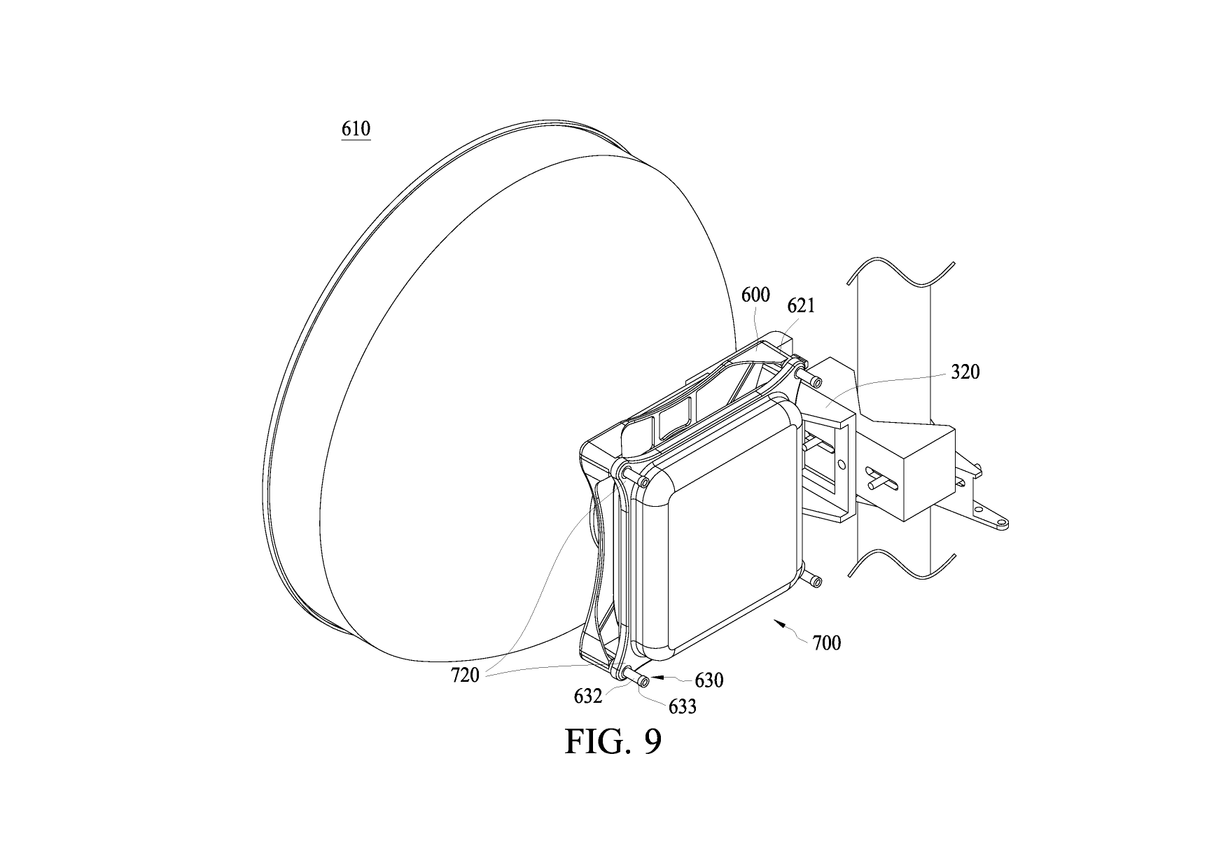

In the embodiment shown in FIGS. 8 and 9, an outdoor unit system 610 comprises an outdoor unit 700 including a positioning part 720 and the above-mentioned holder 600 shown in FIG. 7. The holder 600 is initially fixed on the antenna frame 320. Since the weight of the holder 600 is less than the weight of the outdoor unit 700, the consumer can easily fix the holder 600 on the antenna frame 320. The positioning part 720 defines a hole 721 configured for the supporting part 630 to penetrate. In other words, the bore of the hole 721 is greater than the caliber of the terminal portion 633 so as to allow the terminal portion 633 to pass through the hole 721. After the holder 600 is fixed, the outdoor unit 700 can be temporarily positioned on the holder 600 by hanging the outdoor unit 700 on the intermediate portion 632 of the supporting part 630. Particularly, the supporting part 630 may pass through the hole 721 defined by the positioning part 720 and then the intermediate portion 632 of the supporting part 630 can support the positioning part 720 for aligning the outdoor unit 700 with the frame 600. Finally, screws or studs (not shown) are capable of passing through the lumen of the supporting part 630 to engage the inner threaded wall (not shown) inside the cylinder 621 for fixing the outdoor unit 700 as shown in FIG. 9.

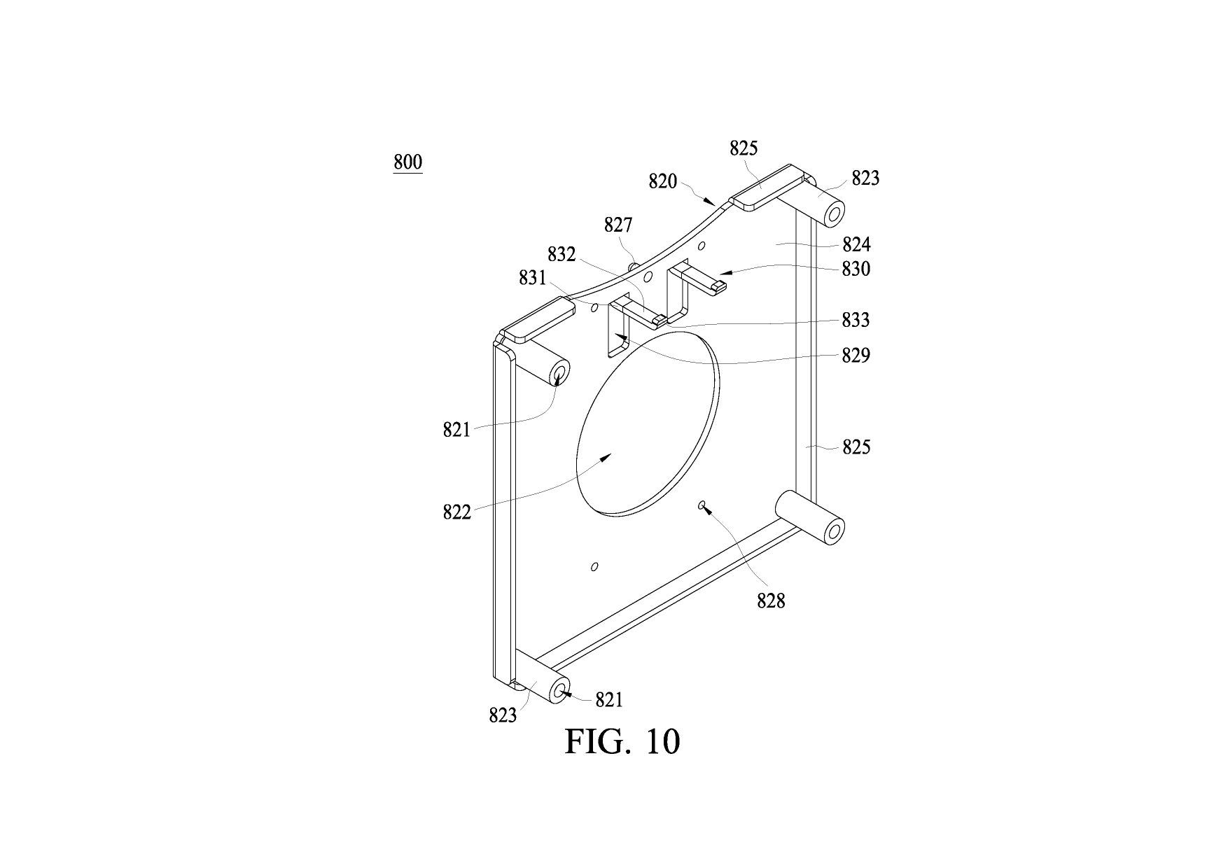

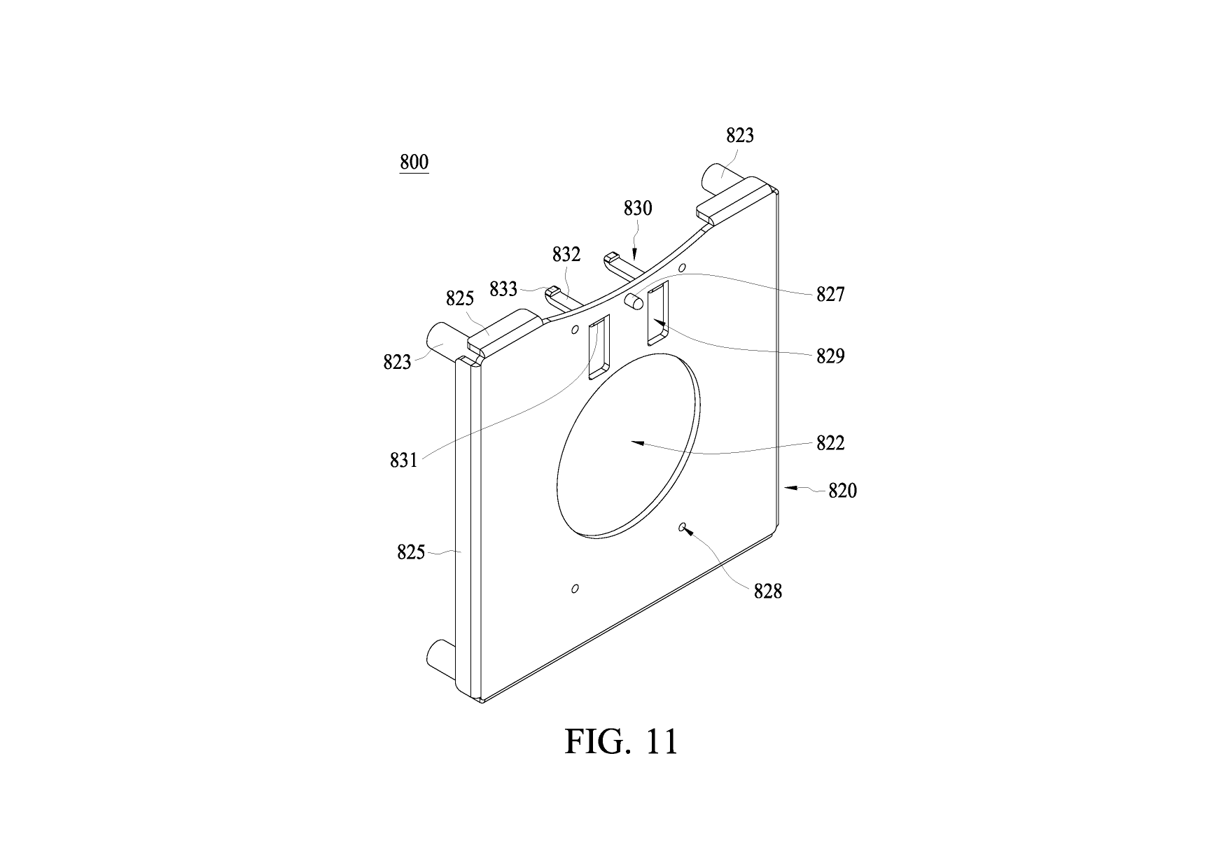

In the embodiment shown in FIGS. 10 and 11, a holder 800 comprises a frame 820 and two supporting parts 830. Since the frame 820 of the holder 800 is an integrated metal piece, the holder 800 could save the cost of molded part. Most sides of the frame 820 can be bent to form the stabilizing parts 825. After the cylinders 823 are soldered on the inner surface 824 of the frame 820 and the supporting part 830 is bended to extend in a direction parallel to the normal direction of the inner surface 824, the holder 800 is formed.

In addition, since the frame 820 further includes a plurality of fixing hole 828, and accommodating openings 829 corresponding to the supporting parts 830, the weight of the frame 820 is less than the weight of the frame 120 (shown in FIG. 1) so that the holder 800 can be easily fixed on the antenna frame 320 (shown in FIG. 2). Furthermore, the center opening 822 and the fixing apertures 821 formed inside the cylinders 823 can further reduce the weight of the frame 820.

In addition, since the frame 820 further include a protruding rod 827, which can engage with the antenna frame 320 (shown in FIG. 2), the holder 800 can be temporarily fixed on the antenna frame 320 so that consumer can use one hand to temporarily position the holder 800 and use the other hand to screw the holder 800 to the antenna frame 320. Furthermore, the protruding rod 827 further provides a function for alignment between the antenna frame 320 and the holder 800.

In the embodiment shown in FIGS. 10 and 11, the supporting parts 830 are bent from the accommodating opening 829. Each of the supporting parts 830 includes a connecting portion 831, an intermediate portion 832, and a terminal portion 833. In the embodiment, the connecting portion 831 is attached to the periphery of the accommodating opening 829. The intermediate portion 832 connecting with the connecting portion 831 is configured for supporting the positioning part 220 (shown in FIG. 2) of the outdoor unit 200 and positioning the outdoor unit 200. The terminal portion 833 connecting with the intermediate portion 832 extends substantially perpendicular to the normal direction of the frame 820 to avoid disengagement of the outdoor unit 200 from the frame 820.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A holder for an outdoor unit, the holder comprising:
a frame including at least one fixing aperture configured for fixing the outdoor unit; and
a supporting part configured for an alignment between the outdoor unit and the frame, the supporting part including, wherein the supporting part is perpendicularly disposed on the frame:
a connecting portion attached to the frame;
an intermediate portion configured for supporting the outdoor unit; and
a terminal portion connecting with the intermediate portion.

2. The holder according to claim 1, wherein the supporting part and the frame are integrated.

3. The holder according to claim 1, wherein the frame further comprises a center opening configured for penetration of the outdoor unit.

4. The holder according to claim 1, wherein the frame further includes at least one cylinder and the fixing aperture is formed at the center of the cylinder.

5. The holder according to claim 4, wherein the frame further includes a stabilizing part connecting with the cylinder.

6. The holder according to claim 1, wherein the side of the frame is formed with an arc-like shape.

7. The holder according to claim 1, wherein the frame further includes a plurality of protruding ribs configured for reinforcing the frame.

8. The holder according to claim 7, wherein the connecting portion is attached to one of the protruding ribs and the intermediate portion connects with the connecting portion.

9. The holder according to claim 1, wherein the terminal portion extends substantially perpendicular to the normal direction of the frame.

10. The holder according to claim 4, wherein the connecting portion is connected to the cylinder.

11. An outdoor unit system, comprising:
an outdoor unit including a positioning part; and
a holder including:
a frame including at least one fixing aperture configured for fixing the outdoor unit; and
a supporting part perpendicularly disposed on the frame and including:
a connecting portion attached to the frame;
an intermediate portion configured for supporting the outdoor unit; and
a terminal portion connecting the intermediate portion;
wherein the supporting part passes through the positioning part, and the supporting part is configured to support the positioning part for aligning the outdoor unit with the frame.

12. The outdoor unit system according to claim 11, wherein the supporting part and the frame are integrated.

13. The outdoor unit system according to claim 11, wherein the frame further comprises a center opening configured for penetration of the outdoor unit.

14. The outdoor unit system according to claim 11, wherein the frame further includes at least one cylinder and the fixing aperture is formed at the center of the cylinder.

15. The outdoor unit system according to claim 14, wherein the frame further includes a stabilizing part connecting with the cylinder.

16. The outdoor unit system according to claim 11, wherein the side of the frame is formed with an arc-like shape.

17. The outdoor unit system according to claim 11, wherein the frame further includes a plurality of protruding ribs configured for reinforcing the frame.

18. The outdoor unit system according to claim 17, wherein the connecting portion is attached to one of the protruding ribs and the intermediate portion connects with the connecting portion.

19. The outdoor unit system according to claim 11, wherein the terminal portion extends substantially perpendicular to the axle of the supporting part.

20. The outdoor unit system according to claim 14, wherein the connecting portion is connected to the cylinder.
